(19) United States
(12) Patent Application Publication
(10) Pub. No.: US 2014/0308488 A1
(43) Pub. Date: Oct. 16, 2014

(54) COMPOSITION CONTAINING ADHESIVE AGENT, RECORDING MEDIUM FOR MANUFACTURING RECORDED MATERIAL, AND RECORDED MATERIAL

(71) Applicant: SEIKO EPSON CORPORATION, Tokyo (JP)

(72) Inventors: Kiyohiko TAKEMOTO, Matsumoto (JP); Masaru HOSHINO, Suwa-gun (JP)

(73) Assignee: SEIKO EPSON CORPORATION, Tokyo (JP)

(21) Appl. No.: 14/230,466

(22) Filed: Mar. 31, 2014

(30) Foreign Application Priority Data
Apr. 10, 2013 (JP) 2013-082410

(51) Int. Cl. C09J 147/00

(52) U.S. Cl. CPC C09J 147/00
USPC 428/206; 524/571

(57) ABSTRACT

A composition containing adhesive agent including an adhesive agent component used for manufacturing a recorded material in which a face opposing to an image forming face of a recording medium, which has an image formed by an inkjet method, is bonded, includes polyisoprene as the adhesive agent component. At least a part of the polyisoprene is included in a state of particles.

### CROSS-REFERENCE TO RELATED APPLICATIONS

This application claims priority to Japanese Patent Application No. 2013-082410 filed on Apr. 10, 2013. The entire disclosure of Japanese Patent Application No. 2013-082410 is hereby incorporated herein by reference.

### BACKGROUND

1. Technical Field

The present invention relates to a composition containing adhesive agent, a recording medium for manufacturing recorded material, and a recorded material.

2. Related Art

In recent years, a service for printing user's image data and manufacturing a photograph bookbinding has been developed.

In the present, in the service for manufacturing a photograph book, it is desired to manufacture a photograph book in high quality with more excellent designability.

For example, a photograph book is manufactured by arranging and overlapping a plurality of printing objects in one side so as to bind them in the one side as a binding margin. Thus, the photograph book with many pages can be provided in light-weight. However, when the one side is arranged in the center and the right and left pages of the photograph book are faced each other, the two facing pages are discontinued visually in the binding side. Because of this, there was a problem that it was difficult to give expressions having an impact in a double-page spread, and as well as, there were the constraints of expressions because the layout was limited to one face.

On the other hand, as a photograph book, also, there was a method of manufacturing a photograph book. In the method, the plural numbers of image receiver papers in which an image was formed on one face were prepared, and in the state that the image receiver papers were folded, another image receiver paper was adhered onto the back surface on which an image was not formed (see e.g., Japanese Unexamined Laid-open Patent Application Publication No. 2011-240529). In the photograph book manufactured in such way, there was a case that it was not required to provide a wide binding margin, and in this case, the double-page spread was continued visually as one image so that the flexibility in the layout was increased. However, conventionally, when such method was used, there were problems such as the deterioration of workability due to the stickiness of the adhesive agent, and difficulty in position adjustment, etc.

Also, the aforementioned problems may be reduced by using hot-melt adhesive agent, but in this case, the following problems are raised. That is, when the thickness of the photograph book is relatively large, it is difficult to apply sufficient heat to near the central portion in the thickness direction so that it is difficult to obtain the sufficient adhesiveness (adhesion). Further, even if the sufficient adhesiveness (adhesion) may be obtained in near the central portion in the thickness direction, the excessive thermal energy is applied to near the surface so that it causes poor productivity of photograph books, and also, it is not preferable in the view of energy saving. In addition, it may cause harmful effect to an image, and furthermore, it may adversely affect durability of the photograph books.

### SUMMARY

An object of the present invention is to provide a composition containing adhesive agent that can be used to produce a recorded material (photograph book, etc.), in which a face opposing to an image forming face of a recording medium is bonded, with good productivity while effectively preventing it from occurring the problems of the deterioration of workability due to the stickiness of the adhesive agent and difficulty in position adjustment, etc. Also, an object of the present invention is to provide a recording medium for manufacturing recorded material that can be used to produce a recorded material (photograph book, etc.), in which a face opposing to an image forming face of a recording medium is bonded, with good productivity while effectively preventing it from occurring the problems of the deterioration of workability due to the stickiness of the adhesive agent and difficulty in position adjustment, etc. Further, an object of the present invention is to provide a recorded material (photograph book, etc.) in which a face opposing to an image forming face of a recording medium is bonded while effectively preventing it from occurring the problems of difficulty in position adjustment, etc.

These objects are achieved by the present invention as follows.

A composition containing adhesive agent includes an adhesive agent component and it is used for producing a recorded material in which a face opposing to an image forming face of a recording medium, which has an image formed by the inkjet method, is bonded. The composition containing adhesive agent according to an aspect of the invention is characterized to include polyisoprene as the adhesive component, and at least a part of the polyisoprene is included in a state of particles.

Because of this, it enables to provide a composition containing adhesive agent that can be used to produce a recorded material (photograph book, etc.), in which a face opposing to an image forming face of a recording medium is bonded, with good productivity while effectively preventing it from occurring the problems of the deterioration of workability due to the stickiness of the adhesive agent and difficulty in position adjustment, etc.

It is preferable that the composition containing adhesive agent includes water as dispersion medium for dispersing the particles of the aforementioned polyisoprene.

Therefore, it can provide satisfactorily excellent dispersing stability of the particles of polyisoprene in the composition containing adhesive agent so that the production of the recording medium for manufacturing recorded material can be appropriately performed. Also, since water has appropriate volatility, it is more securely prevented from the change in composition during the storage, and it is easily removed during the production of the recording medium for manufacturing recorded material so that it has an advantage to improve the productivity of the recording medium for manufacturing recorded material. Also, a load to the environment can be reduced by using water.

In the composition containing adhesive agent according to another aspect of the invention, it is preferable that the particles are in an average particle diameter of more than or equal to 100 nm and less than or equal to 1 μm.

Therefore, it can provide more satisfactorily excellent dispersing stability of the particles of polyisoprene in the composition containing adhesive agent, and specifically, when an adhesive agent layer is formed by using the inkjet method, the production of recording medium for manufacturing recorded material can be appropriately performed.

In the composition containing adhesive agent according to another aspect of the invention, it is preferable that a weight-average molecular weight of the polyisoprene is more than or equal to 100,000 and less than or equal to 500,000.

Therefore, by only applying pressure without heating and at room temperature of less than or equal to 40° C., the composition containing adhesive agent having excellent adhesiveness can be obtained.

In the composition containing adhesive agent, a content rate of the polyisoprene in the composition containing adhesive agent is preferably more than or equal to 2.5 mass % and less than or equal to 25 mass %.

Therefore, for example, when an adhesive agent layer is formed by using the composition containing adhesive agent, it is possible to discharge ink stably for a longer period of time without causing nozzle clogging or flying bend of the ink droplet, and more high productivity can be obtained.

It is preferable that the composition containing adhesive agent according to another aspect of the invention is discharged by the inkjet method.

Therefore, during the production of the recording medium for manufacturing recorded material, it is realized that patterns on the adhesive agent layer is extremely easily formed.

A recording medium for manufacturing recorded material is used for producing a recorded material in which a face opposing to an image forming face in a recording medium, which has an image formed by the inkjet method, is bonded. By applying a composition containing adhesive agent according to another aspect of the invention, it is characterized to provide an adhesive agent layer.

Because of this, it enables to provide the recording medium for manufacturing recorded material that can be used to produce a recorded material (photograph book, etc.), in which a face opposing to an image forming face of a recording medium is bonded, with good productivity while effectively preventing it from occurring the problems of the deterioration of workability due to the stickiness of the adhesive agent and difficulty in position adjustment, etc.

A recorded material according to an aspect of the invention is provided by bonding a face opposing to an image forming face of a recording medium which has an image formed by the inkjet method. It is characterized to use a composition containing adhesive agent according to the aspect of the invention for bonding the recording medium.

Therefore, it is prevented from occurring the problem of difficulty in position adjustment so as to provide the recorded material (photograph book, etc.) in which a face opposing to an image forming face of a recording medium is bonded.

### DETAILED DESCRIPTION OF EXEMPLARY EMBODIMENTS

Hereinafter, the preferable embodiment of the present invention will be described.

### Composition Containing Adhesive Agent

Initially, the composition containing adhesive agent of the present embodiment will be described.

The composition containing adhesive agent of the present embodiment is used for producing a recorded material (e.g., photograph book, etc.) in which a face opposing to an image forming face of a recording medium such as a paper, which has the image, was bonded, and an adhesive agent component is included so as to apply the back surface of the print surface (printed surface) of the recording medium on which the printing was performed.

In the present embodiment, the image was formed by the inkjet method. Because of this, the size range of the applied recording medium can be more widened. For example, a long recording medium (roll paper, etc.) can be appropriately used. A seamless image can be appropriately formed in the double-page spread so that excellent dynamic feel and excellent luxurious feel of an image can be specifically obtained in the finally obtained recorded material. Also, relatively smaller device can be used as an image forming device. Further, various types of recording mediums such as a mat paper, etc. can be appropriately used.

The composition containing adhesive agent of the present embodiment includes polyisoprene as an adhesive agent component. Because of this, an adhesive agent layer formed by the composition containing adhesive agent suppresses stickiness so that sufficient adhesion strength can be obtained by pressure. Also, even when the thickness of the recorded material to be produced is relatively large (many layers to be adhered are laminated), the uniformity of pressure to the whole area can be high so that variability of adhesion strength can be suppressed in each part. Further, heating is not required during the adhesion so that it is preferred in the view of energy saving. Further, polyisoprene is a material having high flexibility so that when a recording medium for manufacturing recorded material is provided by applying the composition containing adhesive agent of the present embodiment for a recording medium, and when a recorded material of the present embodiment is provided by using the recording medium for manufacturing recorded material, it is prevented that the elasticity of the recording medium unnecessarily becomes high so as to secure easy handling, and it can prevent the adhesive agent layer from breaking due to recording medium bending so that excellent reliability and excellent durability of the recorded material and the recording medium for manufacturing recorded material can be provided. Further, by including polyisoprene, during the production of the recorded material, sufficient adhesion strength can be easily obtained by pressure, and also, when the recording medium for manufacturing recorded material is stored, when the recording mediums for manufacturing recorded material are laminated and stored, and when the rolled recording medium for manufacturing recorded material was wound up, the occurrence of unexpected adhesion (blocking) is surely prevented. Further, the particular odor such as vinyl acetate series or acrylic resins that are commonly used as an adhesive agent is not generated.

Polyisoprene is a compound having a structure polymerizing isoprene(2-methyl-1,3-butadiene).

At least a part of the composition containing adhesive agent includes polyisoprene as dispersoid to be dispersed in the dispersion medium. Therefore, drying efficiency is improved, and the effect that an adhesive agent layer pattern can be precisely formed is obtained.

It is preferable that the particles of polyisoprene in the composition containing adhesive agent are in an average particle diameter of more than or equal to 100 nm and less than or equal to 1 μm. Therefore, more satisfactorily excellent dispersing stability of the particles of polyisoprene in the composition containing adhesive agent can be obtained, and specifically, when an adhesive agent layer is formed by using the inkjet method, the production of recording medium for manufacturing recorded material can be appropriately performed. On the other hand, when the average particle diameter of the particles of polyisoprene is less than the aforementioned lower limit, the stickiness of the adhesive agent layer formed by the composition containing adhesive agent becomes large so that in the case that the rolled recording medium for manufacturing recorded material was wound, there is a possibility that unexpected adhesion (blocking) may be generated. Further, when the average particle diameter of the particles of polyisoprene exceeds the aforementioned upper limit, there is a possibility that excellent adhesiveness may not be obtained.

By the way, the average particle diameter is measured by, for example, a particle size analyzer using a dynamic light scattering method. Pure water is added to emulsion by 100 times, and Nanotrac UPA-EX150 (manufactured by Nikkiso Co., Ltd.) is used for the measurement and it can be shown in 50 mass % average particle diameter. By the way, in the present application, the phrase “average particle diameter” denotes the value calculated by aforementioned way unless otherwise specifically noted.

It is preferable that the weight-average molecular weight of polyisoprene in the composition containing adhesive agent is more than or equal to 100,000 and less than or equal to 500,000. Because of this, higher adhesion strength in the recorded material can be obtained, and also, in the production of the recorded material, sufficient adhesion strength can be obtained by lower pressure so as to attain the miniaturization of the production device of the recorded material and simplifying a structure. Further, by only applying pressure without heating and at room temperature of less than or equal to 40° C., it can provide the composition containing adhesive agent having excellent adhesiveness. On the other hand, when the weight-average molecular weight of polyisoprene is less than the aforementioned lower limit, the flexibility of the formed adhesive agent layer becomes insufficient, it cannot be adhered by only the pressure under room temperature at less than or equal to 40° C. without heating. Further, in the case of the recording medium for manufacturing recorded material of the present embodiment in which the composition containing adhesive agent of the present embodiment is applied to the recording medium, and in the case of the recorded material of the present embodiment by using the aforementioned recording medium for manufacturing recorded material, when the weight-average molecular weight of polyisoprene exceeds the aforementioned upper limit, the elasticity of the recording medium becomes large, the treatability of the recorded material and the recording medium for manufacturing recorded material is reduced, and there is a possibility that the reliability and durability of the recorded material and the recording medium for manufacturing recorded material may be reduced.

By the way, for example, the weight-average molecular weight can be calculated by the gel permeation chromatography (GPC) measurement of the polyisoprene polymer part by using Tosoh Corporation, HLC-8320GPC. In the present application, the phrase “weight-average molecular weight” denotes the value calculated by aforementioned way unless otherwise specifically noted.

The content rate of polyisoprene in the composition containing adhesive agent is preferably more than or equal to 2.5 mass % and less than or equal to 25 mass %. Therefore, for example, when an adhesive agent layer is formed by using the composition containing adhesive agent, it is possible to discharge ink stably for a longer period of time without causing nozzle clogging or flying bend of the ink droplet, and more high productivity can be obtained. On the other hand, in the case that an adhesive agent layer is formed by the composition containing adhesive agent, when the content rate of polyisoprene is less than the aforementioned lower limit, there is a possibility that the productivity to secure the thickness of the adhesive agent layer may be reduced. Further, when the content rate of polyisoprene exceeds the aforementioned upper limit, the stickiness of the composition containing adhesive agent becomes high so that for example, in the case that the production of the recording medium for manufacturing recorded material of the present embodiment is performed, there is a possibility that the treatability (for example, discharge stability by the inkjet method, etc.) of the composition containing adhesive agent may be reduced.

The composition containing adhesive agent of the present embodiment is normally liquid form.

The viscosity of the composition containing adhesive agent of the present embodiment (viscosity measured according to JIS Z8809 at 25° C. by using a vibration type viscometers) is not particularly limited, but it is preferable more than or equal to 2 mPa™s and less than or equal to 15 mPa·s, and more preferably, it is more than or equal to 3 mPa·s and less than 10 mPa·s.

The composition containing adhesive agent of the present embodiment includes at least polyisoprene, but it may be possible to include additional other components.

For example, a solvent for solving polyisoprene and a dispersion medium for dispersing polyisoprene may be included. As the solvent and the dispersion medium, water and water-soluble organic solvent in which the boiling point of approximately 1 atm is more than or equal to 70° C. and less than or equal to 250° C. can make resin to be existed stably in the composition containing adhesive agent, and also, in the case that the composition containing adhesive agent is discharged by the inkjet method, it provides excellent discharge stability of the composition containing adhesive agent, and in addition, it also provides excellent volatility of the composition containing adhesive agent so that it is possible to form an adhesive agent layer pattern with high accuracy. Therefore, it is preferable.

The aforementioned water-soluble organic solvent is preferably an aqueous liquid including at least one selected from lactam, carboxylic acid ester, alkylene glycol ether, and alcohol. Among them, the aqueous liquid including 2-pyrrolidone(γ-butyrolactam), lactic acid ester, alkylene glycol ether, and alcohol is more preferable.

As the aforementioned water-soluble organic solvent, it is not limited to the followings, but for example, it includes ethanol (boiling point 78° C.), N-methyl-2-pyrrolidone (boiling point 202° C.), N-methyl-2-pyrrolidone (boiling point 212° C.), 2-pyrrolidone (boiling point 245° C.), dimethyl sulfoxide (boiling point 189° C.), methyl lactate (boiling point 145° C.), ethyl lactate (boiling point 155° C.), isopropyl lactate (boiling point 168° C.), butyl lactate (boiling point 188° C.), ethylene glycol monomethyl ether (boiling point 124° C.), ethylene glycol dimethyl ether (boiling point 85° C.), ethylene glycol monomethyl ether acetate (boiling point 145° C.), diethylene glycol monomethyl ether (boiling point 194° C.), diethylene glycol dimethyl ether (boiling point 162° C.), diethylene glycol ethyl methyl ether (boiling point 176° C.), diethylene glycol diethyl ether (boiling point 189° C.), propylene glycol monomethyl ether (boiling point 120° C.), propylene glycol dimethyl ether (boiling point 97° C.), dipropylene glycol monomethyl ether (boiling point 188° C.), dipropylene glycol dimethyl ether (boiling point 171° C.), 1,4-dioxane (boiling point 101° C.), ethylene glycol (boiling point 197° C.), diethylene glycol (boiling point 244° C.), propylene glycol (boiling point 188° C.), dipropylene glycol (boiling point 232° C.), 1,3-propanediol (boiling point 212° C.), 1,4-butanediol (boiling point 230° C.), hexylene glycol (boiling point 198° C.), 2,3-butanediol (boiling point 77° C.), n-butanol (boiling point 118° C.), 1,2-hexanediol (boiling point 224° C.), 1,2-pentanediol (boiling point 206° C.), diethylene glycol monobutyl ether (boiling point 116° C.), and diethylene glycol monopropyl ether (boiling point 153° C.).

The water-soluble organic solvent in which the boiling point of approximately 1 atm is more than or equal to 70° C. and less than or equal to 250° C. may be used by 1 kind singly or more than 2 kinds.

Specifically, the composition containing adhesive agent preferably includes water as dispersion medium to disperse the particles of polyisoprene. Because of this, sufficient excellent dispersion stability of the particles of polyisoprene in the composition containing adhesive agent can be obtained so that the production of the recording medium for manufacturing recorded material can be appropriately performed. Further, since water has appropriate volatility, it is more securely prevented from the change in composition during the storage, and it is easily removed during the production of the recording medium for manufacturing recorded material so that it has an advantage to improve the productivity of the recording medium for manufacturing recorded material. Also, a load to the environment can be reduced by using water.

Further, the composition containing adhesive agent of the present embodiment may include a surfactant. Because of this, particularly excellent adhesion by the composition containing adhesive agent can be obtained. Further, when the composition containing adhesive agent includes water-soluble resin, particularly excellent dispersion stability of polyisoprene particles as dispersoid and particularly excellent storage stability of the composition containing adhesive agent can be obtained. As a result, for example, in the case that the composition containing adhesive agent is discharged by the inkjet method, particularly excellent discharge stability of the composition containing adhesive agent can be obtained. Further, in the production of the recording medium for manufacturing recorded material, the generation of unexpected variability for the film thickness of the formed adhesive agent layer can be effectively prevented.

As the surfactant, for example, cationic surfactant, anionic surfactant, nonionic surfactant, amphoteric surfactant, etc. can be used. As a preferable surfactant, it includes at least one surfactant selected from a group including acetylene glycol-based surfactant and silicone-based surfactant.

As the acetylene glycol-based surfactant, for example, it includes 2,4,7,9-tetramethyl-5-decyne-4,7-diol, 3,6-dimethyl-4-octyne-3,6-diol, 3,5-dimethyl-1-hexyne-3-ol, 2,4-dimethyl-5-hexyne-3-ol. As a commercially available acetylene glycol-based surfactant, for example, Olfine E1010, STG, Y, Surfinol 104E, 104H, 104A, 104BC, 104DPM, 104PA, 104PG-50, 104S, 420,465,485, TG, SE, SE-F, 61,82, DF-110D (all trade names, manufactured by Nissin Chemical Industry Co., Ltd.), Acetylenol E00, E00P (all trade names, manufactured by Kawaken Fine Chemicals Co. Ltd.) can be used.

As a silicon-based surfactant, polysiloxane compound is preferably used, and as a specific example of polysiloxane compound, it includes polyether-modified organosiloxane. As a commercially available silicon-based surfactant, BYK-306, BYK-307, BYK-333, BYK-341. BYK-345, BYK-346, BYK-347, BYK-348, BYK-UV3500, 3510, 3530, 3570 (all trade names, manufactured by BYK Japan KK) can be used.

More preferable surfactant is the combination of silicon-based surfactant and acetylene glycol-based surfactant in which the HLB value is less than or equal to 17.

Further, the surface tension of the aforementioned composition containing adhesive agent is preferably in the range of more than or equal to 23.0 mN/m and less than or equal to 40.0 mN/m by combining the aforementioned water-soluble organic solvent and surfactant. It is more preferably in the range of more than or equal to 25.0 mN/m and less than or equal to 35.0 mN/m. When the surface tension of the composition containing adhesive agent is within the aforementioned ranges, excellent discharge stability in an inkjet head can be obtained.

The composition containing adhesive agent of the present embodiment may include components other than the aforementioned components (other components). As such components, for example, it includes antiseptic and fungicide, pH adjusting agent, antioxidant, metal trapping agent, humectant, dispersant, dispersion aid, filler, adhesion accelerator, aggregation prevention agent, photo-curable resin, thermosetting resin, polymerization initiator, polymerization inhibitor, and like. As the antiseptic and fungicide, for example, it includes sodium benzoate, pentachlorophenol sodium, 2-pyridinethiol-1-oxide sodium, sodium sorbate, sodium dehydroacetate, 1,2-dibenzothiazolin-3-one (Proxel-CRL, Proxel-BDN, Proxel-GXL, Proxel-XL2, Proxel-TN manufactured by Arch Chemicals, Inc.).

As the pH adjusting agent, for example, it includes sodium hydroxide, potassium hydroxide, and the like such as inorganic alkali, ammonia, diethanolamine, triethanolamine, tri-isopropanol amine, morpholine, potassium dihydrogen phosphate, and disodium hydrogen phosphate.

As the metal-trapping agent, for example, it includes disodium ethylene-diamine-tetraacetate, and the like.

The composition containing adhesive agent of the present embodiment can be applied to a recording medium in any method. For example, various application methods such as bar coating, spin coating, roll coating, slit coating, brushing, etc., and various printing methods such as offset printing, gravure printing, inkjet method, etc., can be performed, but the inkjet method is preferable. Therefore, extremely easy pattern application on the adhesive agent layer can be realized, and many kinds of photograph books in small quantities can be efficiently produced with low price in short time of period.

### Recording Medium for Manufacturing Recorded Material

Next, the recording medium for manufacturing recorded material of the present embodiment will be described.

The recording medium for manufacturing recorded material of the present embodiment is obtained by applying the aforementioned composition containing adhesive agent of the present embodiment to a recording medium. Because of this, the recording medium for manufacturing recorded material can be used to produce a recorded material (photograph book, etc.), in which a face opposing to an image forming face of a recording medium was bonded, with good productivity while effectively preventing it from occurring the problems of the deterioration of workability due to the stickiness of the adhesive agent and difficulty in position adjustment, etc. Further, the adhesive agent layer formed by using the composition containing adhesive agent of the present embodiment has appropriate gripping force so that for example, when an image is formed on the recording medium for manufacturing recorded material, which forms the adhesive agent layer (adhesive agent layer formed by using the composition containing adhesive agent of the present embodiment), by using the inkjet printer, excellent conveyance of the recording medium for manufacturing recorded material can be realized and it can surely prevent the rollers of the inkjet printer from running idle, and the desired image can be surely formed on a target region. Furthermore, by including the adhesive agent layer formed by using the composition containing adhesive agent of the present embodiment, it can surely prevent the inside of the inkjet printer from generating the paper powder derived from a recording medium so that it can surely prevent the inkjet printer from occurring malfunction, failure, etc.

For example, as a recording medium, it includes various kinds of papers such as plain paper, coated paper, photo paper, offset printing paper, etc., and plastic film, metal foil, fabric, etc. Also, as a recording medium, it may be a roll paper. For example, when the roll paper is used as a recording medium, before applying the composition containing adhesive agent, or after applying the composition containing adhesive agent, it can be cut in a predetermined length.

The thickness of a recording medium is not particularly limited, but it is preferably 30 μm, and more preferably, it is more than or equal to 50 μm and less than or equal to 200 μm. In the case that the thickness of the recording medium is relatively large, when the hot-melt adhesive agent is used, it is difficult to apply sufficient heat to near the central part in the thickness direction, and it is difficult to obtain sufficient adhesiveness (adhesion), and also, it has disadvantage in the view of energy saving. However, in the present embodiment, even when the thickness of the recording medium is relatively large as described above, the occurrence of the aforementioned problems can be surely prevented. That is, a remarkable effect of the present embodiment is attained when the thickness of the recording medium is relatively large as described above. Also, when the thickness of the recording medium is a value within the aforementioned ranges, it can provide particularly excellent luxurious feel and excellent durability of a recorded material (photograph book, etc.) to be manufactured.

The composition containing adhesive agent may be applied to whole surface of the recording medium or may be only applied to a part of the surface. For example, the composition containing adhesive agent may be applied to the recording medium in the configuration of linear, point-like (dots), and the like. Further, in the production of the recorded material, the composition containing adhesive agent may be applied to only one face among the faces of the recording medium for manufacturing recorded material to be bonded.

Specifically, in comparison with the case that the composition containing adhesive agent is only applied to an edge part, when the composition containing adhesive agent is applied to whole surface of the recording medium, it surely prevents the recording medium from generating a gap in the region where the composition is not applied, and moreover, it can particularly facilitate turning-over of pages. Further, eventually, it can provide particularly excellent luxurious feel recorded material (photograph book, etc.).

The application amount of the composition containing adhesive agent to a recording medium per unit area is not particularly limited, but it is preferably in the ranges of more than or equal to 0.1 g/m² and less than or equal to 20 g/m², and more preferably, it is more than or equal to 0.5 g/m² and less than or equal to 10 g/m². Because of this, it can provide particularly excellent adhesion strength in the recorded material finally obtained.

The thickness of the adhesive agent layer (dried film thickness) formed by the composition containing adhesive agent is not limited, but it is preferably in the ranges of more than or equal to 1 μm and less than or equal to 10 μm, and more preferably, it is more than or equal to 2 μm and less than or equal to 5 μm. Because of this, it can provide particularly excellent adhesion strength in the recorded material finally obtained.

In the present embodiment, the application of the composition containing adhesive agent to the recording medium may be performed before the image formation (photographic printing) to the recording medium or may be performed after the image formation (photograph printing) to the recording medium. However, it is preferable to be performed before the image formation (photographic printing) to the recording medium. Therefore, the recording medium for manufacturing recorded material produced by using the composition containing adhesive agent of the present embodiment can be preliminary prepared for producing the recorded material (photograph book, etc.) in which the image to be formed is normally different depending on the customer so that the delivery time of the recorded material (photograph book, etc.) can be shortened.

### Recorded Material

Next, the recorded material of the present embodiment will be described.

The recorded material of the present embodiment is produced by bonding the face opposing to the image forming face of the paper which has an image formed by the inkjet method, and using the aforementioned composition containing adhesive agent of the present embodiment for bonding the recording medium. Therefore, it can provide the recorded material (photograph book, etc.) in which the face opposing to the image forming face of the recording medium was bonded while effectively preventing it from occurring the problem of difficulty in position adjustment, etc.

The image data contained in the recorded material may be recorded in a recording media such as a SD card, an USB memory, a DVD, and the like that the user (customer) brings, or the data may be received through the internet connection, etc.

By the way, in the present embodiment, as a recorded material, it may be anything in which the face opposing to the image forming face of the recording medium, which has an image formed by the inkjet method, was bonded. Specifically, for example, it includes a photograph book, a calendar, a greeting card, a catalog, an independent book, a paperback book, a dissertation, etc.

The recorded material of the present embodiment is manufactured by bonding the face on which the composition containing adhesive agent of the recording medium for manufacturing recorded material was applied (face opposing to the image forming face) in the state that an image was formed on the face opposing to the face on which the aforementioned composition containing adhesive agent of the recording medium for manufacturing recorded material of the present embodiment was applied.

Bonding the recording medium for manufacturing recorded material can be performed by applying pressure in the state that the face opposing to the face on which an image of the recording medium for manufacturing recorded material was formed is opposed.

In this case, the pressure is preferably more than or equal to 3 kgf/cm² and less than or equal to 30 kgf/cm², and more preferably, it is more than 7 kgf/cm² and less than or equal to 13 kgf/cm². Therefore, it can surely manufacture a recorded material having high adhesion strength with excellent productivity while preventing an increase in size. On the other hand, when the pressure is lower than the aforementioned lower limit, there is a possibility that may be difficult to obtain sufficient adhesion strength depending on patterns, application amount, etc. of the composition containing adhesive agent. Further, when the pressure exceeds the aforementioned upper limit, there is a possibility that color migration to another page depending on ink components, and like used for an image formation may be generated.

For example, a plurality of recording mediums for manufacturing recorded material may be used for manufacturing the recording medium, or one recording medium for manufacturing recorded material may be used. More specifically, the recorded material of the present embodiment may be manufactured by using the plurality of recording mediums for manufacturing recorded material and bonding the faces of these recording medium for manufacturing recorded material, on which the composition containing adhesive agent was applied (face opposing to the image forming face), each other, or it may be manufactured by folding one recording medium for manufacturing recorded material and bonding the opposed face on which the composition containing adhesive agent was applied (face opposing to the image forming face). Further, a layer (adhesive agent layer) formed by the composition containing adhesive agent of the present embodiment can be provided in at least one side of the faces to be bonded.

The thickness of the recorded material is not particularly limited, but it is preferably more than or equal to 3 mm, and more preferably, it is more than or equal to 5 mm and less than or equal to 50 mm. Therefore, when the thickness of the recorded material is relatively large, in the case that the hot-melt adhesive agent is used for manufacturing the recorded material, it is difficult to apply heat to near the central part in the thickness direction so that it is difficult to have sufficient high adhesiveness (adhesion) and it has disadvantages in the views of productivity of the recorded material, energy saving, or durability of the recorded material, but in the present embodiment, even when the thickness of the recorded material is relatively large as described above, the generation of the aforementioned problems can be surely prevented. That is, a remarkable effect of the present embodiment is attained when the thickness of the recorded material is relatively large as described above. Also, when the thickness of the recorded material is a value within the aforementioned ranges, it can provide particularly excellent luxurious feel and excellent durability of the recorded material.

The page number (including front cover, back cover) of the recorded material (photograph book, calendar, etc.) is not particularly limited, but it is preferably more than or equal to 4 pages, and more preferably, it is more than or equal to 8 pages and less than or equal to 80 pages. Therefore, when the page number of the recorded material is relatively large, in the case that the hot-melt adhesive agent is used for manufacturing the recorded material, it is difficult to apply heat to near the central part in the thickness direction so that it is difficult to have sufficient high adhesiveness (adhesion) and it has disadvantages in the views of productivity of the recorded material, energy saving, or durability of the recorded material, but in the present embodiment, even when the page number of the recorded material is relatively large as described above, the generation of the aforementioned problems can be surely prevented. That is, a remarkable effect of the present embodiment is attained when the page number of the recorded material is relatively large as described above. Also, when the page number of the recorded material is a value within the aforementioned ranges, it can provide particularly excellent luxurious feel and excellent durability of the recorded material.

The above description of the present embodiment was discussed based on the preferable embodiments, but the present embodiment is not limited to these embodiments.

### EXAMPLES

### Example 1

1 Manufacturing Composition Containing Adhesive Agent

The composition containing adhesive agent was manufactured as follows.

Average particle diameter: 300 nm polyisoprene particles (weight-average molecular weight of polyisoprene: 200,000), 1,2-hexandiol (hereinafter referred to as “1,2-HD”), 2-pyrrolidone (hereinafter referred to as “2-Py”), propylene glycol (hereinafter referred to as “PG”), BYK-348 as a surfactant, Proxel-XL2 (antiseptic, manufactured by Arch Chemicals Ltd., trade name), and ion-exchange water are added, and it was stirred for 20 min at 40° C. After stirring, it was filtered by the membrane-filter in the diameter of 5 μm, and the quantity (pts. mass) of the composition containing adhesive agent as shown in Table 1 was prepared.

2 Production of Recording Medium for Manufacturing Recorded Material

By using the composition containing adhesive agent obtained as described above, a recording medium for manufacturing recorded material was manufactured as follows.

Initially, a roll paper (manufactured by Seiko Epson Corporation, Super Fine paper roll type, 210 mm×20 m) was prepared as a recoding medium.

Next, in the state that the drive waveform of piezoelectric element was optimized, the composition containing adhesive agent was applied to whole surface of one side of the recording medium by the inkjet method. The application amount of the composition containing adhesive agent to the recording medium per unit was 30 g/m².

After that, by blowing 70° C. of warm air for 1 minute, the adhesive agent layer was formed. The thickness (dried film thickness) of the formed adhesive agent layer was 3 μm.

3 Formation of Image

The recording medium for manufacturing recorded material obtained as described above was cut in a predetermined length, and by using the inkjet printer (manufactured by Seiko Epson Corporation, PX-5002), a predetermined image was formed on the face opposing to the face on which the adhesive agent layer was formed.

### Examples 2 and 3

By changing the components used for manufacturing the composition containing adhesive agent and blending quantity, it becomes the composition as shown in Table 1. Other than that, the composition containing adhesive agent was manufactured in the same manner as Example 1 as described above. After that, by using the obtained composition containing adhesive agent, the recording medium for manufacturing recorded material was manufactured and an image was formed in the same manner as Example 1 as described above.

### Comparative Example 1

1,2-HD, 2-Py, PG, emulsion type resin as an adhesive agent component, Polyzol AD17 (manufactured by SHOWA DENKO K.K, trade name, ethylene/vinyl acetate resin emulsion, glass transition temperature (Tg): −10° C., active component 56 mass %), BYK-348, Proxel-XL2, and ion-exchange water are mixed, and after stirring it at 40° C. for 20 minutes, it is filtered by the membrane-filter in the diameter of 5 μm so that the quantity (pts. mass) of the composition containing adhesive agent shown in Table 1 was prepared.

After that, the recording medium for manufacturing recorded material was manufactured in the same manner as Example 1 by using the obtained composition containing adhesive agent, and an image was formed.

### Comparative Example 2

1,2-HD, 2-Py, PG, emulsion type resin as an adhesive agent component, Polyzol AM710 (manufactured by SHOWA DENKO K.K, trade name, acrylate resin emulsion, glass transition temperature (Tg): 56° C., active component 51 mass %), BYK-348, Proxel-XL2, and ion-exchange water are mixed, and after stirring it at 40° C. for 20 minutes, it is filtered by the membrane-filter in the diameter of 5 μm so that the quantity (pts. mass) of the composition containing adhesive agent shown in Table 1 was prepared.

After that, the recording medium for manufacturing recorded material was manufactured in the same manner as Example 1 by using the obtained composition containing adhesive agent, and an image was formed.

The conditions of the compositions containing adhesive agent in the aforementioned respective Examples and Comparative Examples were summarized and shown in Table 1.

TABLE I

| | | | | | | | | | | | | | Manufacturing Condition | |
|---|---|---|---|---|---|---|---|---|---|---|---|---|---|---|
| | | | | | | | | | | | | | and Configuration of | |
| | | | | | | | | | | | | | Recording Medium for | |
| | | | | | | | | | | | | | Manufacturing Recorded | |
| | | | | | | | | | | | | | Material | |
| | | | | | | Content Ratio of Composition Containing | | | | | | | Applica- | Thick- |
| | Adhesive Agent Component | | | | | Adhesive Agent (mass %) | | | | | | | tion | ness of |
| | | | | Weight- | | Adhesive | Water-soluble | | | Surfac- | Anti- | | Amount | Adhesive |
| | | Average | | average | Tg | Agent | Organic Solvent | | | tant | septic | Ion- | (g/m²) to | Agent |
| | Type of | Particle | | Molecular | Resin | Component | 1,2- | 2- | | BYK- | Proxel- | exchange | Recording | Layer |
| | Resin | Diameter | | Weight | (° C.) | Resin | HD | Py | PG | 348 | XL2 | water | Medium | (μm) |
| Example 1 | Poly- | 300 | nm | 200,000 | −60° C. | 10 | 5 | 4 | 12 | 1 | 02 | Residual | 30 | 3 |
| | isoprene | | | | | | | | | | | | | |
| Example 2 | Poly- | 100 | nm | 100,000 | −60° C. | 25 | 5 | 4 | 12 | 1 | 02 | Residual | 40 | 10 |
| | isoprene | | | | | | | | | | | | | |
| Example 3 | Poly- | 1 | μm | 500,000 | −60° C. | 2.5 | 5 | 4 | 12 | 1 | 02 | Residual | 100 | 2 |
| | isoprene | | | | | | | | | | | | | |
| Compara- | Ethylene/ | 200 | nm | 200,000 | −10° C. | 10 | 5 | 4 | 12 | 1 | 02 | Residual | 30 | 3 |
| tive | Vinyl | | | | | | | | | | | | | |
| Example 1 | acetate | | | | | | | | | | | | | |
| Compara- | Acrylate | 150 | nm | 200,000 | 56° C. | 10 | 5 | 4 | 12 | 1 | 02 | Residual | 30 | 3 |
| tive | | | | | | | | | | | | | | |
| Example 2 | | | | | | | | | | | | | | |

4 Evaluation

4.1 Productivity

In the aforementioned respective Examples and Comparative Examples, the recording medium for manufacturing recorded material on which an image (print part) was formed was alternately folded in mountain fold and valley fold in a predetermined width, and 20 sheets, 40 pages were overlapped so as to oppose the parts each other where the adhesive agent layer of the recording medium for manufacturing recorded material was formed.

After that, it was pressed in a predetermined pressure for 3 minutes in the room temperature, and the photograph book as a recorded material was manufactured so that the productivity of the recorded material was evaluated according to the following standards.

AA: Enabling adhesion in the pressure less than 7 kg/cm² so that the productivity of the recorded material is excellent.

A: Enabling adhesion in the pressure more than or equal to 7 kg/cm² and less than 13 kg/cm² so that the productivity of the recorded material is excellent.

B: Enabling adhesion in the pressure more than or equal to 13 kg/cm² and less than 30 kg/cm² so that the productivity of the recorded material is good.

C: Enabling adhesion in the pressure more than or equal to 30 kg/cm² and less than 60 kg/cm² so that the productivity of the recorded material is slightly not-good.

D: Enabling adhesion in the pressure more than or equal to 60 kg/cm² and less than 100 kg/cm² so that the productivity of the recorded material is not-good.

E: Impossible to adhere in the pressure of 100 kg/cm² so that the productivity of the recorded material is immeasurable.

4.2 Adhesiveness (Appearance)

Each photograph book manufactured in the aforementioned 4.1 was visually observed, and the adhesiveness of the recorded material was evaluated according to the following standards.

A: Recording medium for manufacturing recorded material is surely adhered, and unexpected floating, peeling, variation in thickness, and protrusion of adhesive agent are not recognized.

B: Recording medium for manufacturing recorded material is surely adhered, and unexpected floating, peeling, variation in thickness, and protrusion of adhesive agent are not almost recognized.

C: Recording medium for manufacturing recorded material is adhered, and at least one of unexpected floating, peeling, variation in thickness, and protrusion of adhesive agent is slightly recognized.

D: Recording medium for manufacturing recorded material is adhered, and at least one of unexpected floating, peeling, variation in thickness, and protrusion of adhesive agent is clearly recognized.

E: Recording medium for manufacturing recorded material is adhered, and at least one of unexpected floating, peeling, variation in thickness, and protrusion of adhesive agent is notably recognized.

4.3 Blocking Evaluation

For each recording medium for manufacturing recorded material manufactured in section 2 of the aforementioned respective Examples and Comparative Examples, it is wound in φ2 inch paper core under the predetermined environment and it is left for 1 hour. Then, it is tested whether or not the unexpected adhesion (blocking) between the surface for printing and the adhesive agent layer is generated, and it was evaluated according to the following standards.

A: Blocking is not generated under the environment of 40° C.

B: Blocking is not generated under the environment of more than or equal to 25° C. and less than 40° C.

C: Blocking is not generated under the environment of more than or equal to 5° C. and less than 25° C.

E: Blocking is generated under the environment of less than 5° C.

These results are shown in Table 2.

TABLE 2

| | | | Blocking |
|---|---|---|---|
| | Productivity | Adhesiveness | Evaluation |
| Example 1 | B | A | A |
| Example 2 | A | A | A |
| Example 3 | B | A | A |
| Comparative Example 1 | B | D | E |
| Comparative Example 2 | E | — | A |

As is evident from Table 2, the satisfactory results were obtained in the present embodiment, but the satisfactory results were not obtained in Comparative Examples. Specifically, in Comparative Example 1 using ethylene/vinyl acetate copolymer resin of low Tg that is generally and widely used as an adhesive agent component, unexpected floating, peeling, and protrusion of adhesive agent are clearly recognized in the adhesion part of the recording medium for manufacturing recorded material so that the adhesiveness is not good. In addition, in the blocking evaluation, the blocking was generated under the environment of less than 5° C. Also, in Comparative Example 2 using acrylate resin that is widely used as a hot-melt adhesive agent as an adhesive agent component, the adhesion was impossible even when it was pressed in high 100 kg/cm² so that the production of the recorded material was impossible. By the way, when the composition containing adhesive agent of Comparative Example 1 was preliminary applied to the recording medium, and after that, an image formation was performed to the recording medium by the inkjet method, the paper jam was generated in the inside of the inkjet printer (liquid droplet discharge device) so that the desired image could not be formed.

### General Interpretatoin of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

1. A composition containing adhesive agent including an adhesive agent component used for manufacturing a recorded material in which a face opposing to an image forming face of a recording medium, which has an image formed by an inkjet method, is bonded, comprising:
polyisoprene as the adhesive agent component;
at least a part of the polyisoprene being included in a state of particles.

2. The composition containing adhesive agent according to claim 1, further comprising
water as dispersion medium for dispersing the particles of the polyisoprene.

3. The composition containing adhesive agent according to claim 1, wherein
the particles of the polyisoprene are in an average particle diameter of more than or equal to 100 nm and less than or equal to 1 μm.

4. The composition containing adhesive agent according to claim 1, wherein
a weight-average molecular weight of the polyisoprene is more than or equal to 100,000 and less than or equal to 500,000.

5. The composition containing adhesive agent according to claim 1, wherein
a content rate of the polyisoprene in the composition containing adhesive agent is more than or equal to 2.5 mass % and less than or equal to 25 mass %.

6. The composition containing adhesive agent according to claim 1, wherein
the composition containing adhesive agent is discharged by the inkjet method.

7. A recording medium for manufacturing recorded material for manufacturing a recorded material in which a face opposing to an image forming face of a recording medium, which has an image formed by an inkjet method, is bonded, comprising:
an adhesive agent layer that is formed by applying the composition containing adhesive agent according to claim 1.

8. A recorded material in which a face opposing to an image forming face of a recording medium, which has an image formed by an inkjet method, is bonded, comprising:
the composition containing adhesive agent according to claim 1 that is used for bonding.
